(19) United States
(12) Patent Application Publication
(10) Pub. No.: US 2024/0078064 A1
(43) Pub. Date: Mar. 7, 2024

(54) CONTROL APPARATUS, CONTROL METHOD, AND NON-TRANSITORY COMPUTER READABLE MEDIUM

(71) Applicant: FUJIFILM BUSINESS INNOVATION CORP., Tokyo (JP)

(72) Inventors: Kazunari TANAKA, Kanagawa (JP); Sho NAGASE, Kanagawa (JP)

(73) Assignee: FUJIFILM BUSINESS INNOVATION CORP., Tokyo (JP)

(21) Appl. No.: 18/182,519

(22) Filed: Mar. 13, 2023

(30) Foreign Application Priority Data
Sep. 5, 2022 (JP) 2022-140767

(51) Int. Cl. G06F 3/12; G06V 20/52

(52) U.S. Cl. CPC G06F 3/1238; G06F 3/1222; G06V 20/52

(57) ABSTRACT

A control apparatus includes a processor configured to: receive a print instruction from a user terminal; execute a print control that causes a printer to print without involving an operation of giving a print instruction performed by a user on the printer, and causes printed material produced by the printing to be delivered into a delivery unit from which the printed material is retrievable without user authentication; and perform a resolution process if an unauthorized state occurs in which a non-instructing user who is different from an instructing user who gave the print instruction retrieves the printed material from the delivery unit, the resolution process promoting resolution of the unauthorized state.

### CROSS-REFERENCE TO RELATED APPLICATIONS

This application is based on and claims priority under 35 USC 119 from Japanese Patent Application No. 2022-140767 filed Sep. 5, 2022.

### BACKGROUND

### (i) Technical Field

The present disclosure relates to a control apparatus, a control method, and a non-transitory computer readable medium.

### (ii) Related Art

Japanese Patent No. 6456042 discloses an image forming apparatus that outputs printed material in accordance with an instruction from a user, the image forming apparatus being provided with: a communication means for communicating with a sensor that detects, and captures an image of, a person present within a prescribed range of the image forming apparatus; an analysis means for identifying the user on the basis of a captured image that the communication means has received from the sensor; a determination means for determining that the user identified by the analysis means is identical to a person who performs a prescribed action of obtaining the printed material if a captured image that the communication means has received from the sensor corresponds to the prescribed action, the captured image being received in response to the printed material being outputted according to an instruction given by the user identified by the analysis means; and a notification means that provides a prescribed notification if the determination means determines that the user and the person are not identical.

Japanese Patent No. 6332140 discloses an image forming apparatus provided with: a network interface unit that communicates with external equipment; a storage unit storing user information to be used when authenticating a user; an image forming unit that prints according to a print instruction from a computer of a user and outputs printed material to a paper output tray; a user authentication unit that authenticates the user by using the user information from when the print instruction is received; a printed material pickup management unit that transmits to the computer a printing completion notification indicating that the printing is complete; a collection detection unit capable of detecting that the printed material has been collected from the paper output tray; an operation input unit; and a display unit, wherein: when the print instruction is received, the user authentication unit performs a first authentication for authenticating the user who gave the print instruction, and if the printed material is collected from the paper output tray, the user authentication unit performs a second authentication for authenticating the collector who collects the printed material from the paper output tray; if the printed material is collected from the paper output tray and the collector is different from the user who have the print instruction, the printed material pickup management unit transmits, to the computer of the user who have the print instruction, a printed material takeaway notification indicating that the printed material has been taken away; the storage unit stores a user authentication history, that is, a history of users authenticated by the user authentication unit; after the printed material takeaway notification is transmitted, the user authentication unit performs a third authentication that authenticates the user who took away the printed material; if the user authentication based on the third authentication by the user authentication unit is successful, the printed material pickup management unit additionally causes the display unit to display a printed material loss reporting screen for reporting the loss of the printed material, determines whether a printed material loss report is received from the user subject to the third authentication, and if a report indicating that the printed material has been lost is received through the operation input from the user subject to the third authentication, the printed material pickup management unit causes the display unit to display, on a basis of the user authentication history, a list of collectors who were subject to the second authentication for collecting the printed material from the paper output tray after the completion of the printing for the user who issued the printed material loss report.

### SUMMARY

A control apparatus is conceivable in which, if a print instruction is received from a user terminal, the control apparatus executes a print control that causes a printer to print without involving an operation of giving a print instruction performed by a user on the printer, and causes printed material produced by the printing to be delivered into a delivery unit from which the printed material is retrievable without user authentication.

Since such a control apparatus causes the printed material to be delivered into a delivery unit from which the printed material is retrievable without user authentication, there is a possibility that a non-instructing user different from the instructing who gave the print instruction could retrieve the printed material from the delivery unit and take away the printed material.

Aspects of non-limiting embodiments of the present disclosure relate to a control apparatus that mitigates the takeaway of printed material by a non-instructing user compared to the case of performing only print control with respect to a printer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a control apparatus including a processor configured to: receive a print instruction from a user terminal; execute a print control that causes a printer to print without involving an operation of giving a print instruction performed by a user on the printer, and causes printed material produced by the printing to be delivered into a delivery unit from which the printed material is retrievable without user authentication; and perform a resolution process if an unauthorized state occurs in which a non-instructing user who is different from an instructing user who gave the print instruction retrieves the printed material from the delivery unit, the resolution process promoting resolution of the unauthorized state.

### BRIEF DESCRIPTION OF THE DRAWINGS

An exemplary embodiment of the present disclosure will be described in detail based on the following figures, wherein:

FIG. 1 is a schematic diagram illustrating an information processing system according to an exemplary embodiment;

FIG. 2 is a block diagram illustrating an example of a hardware configuration of a multi-function device according to the exemplary embodiment;

FIG. 3 is a block diagram illustrating an example of a hardware configuration of a user terminal according to the exemplary embodiment;

FIG. 4 is a block diagram illustrating an example of a hardware configuration of an information processing apparatus according to the exemplary embodiment;

FIG. 5 is a block diagram illustrating an example of a functional configuration of the information processing apparatus according to the exemplary embodiment; and

FIG. 6 is a flowchart illustrating an example of a flow of control processing executed by the information processing apparatus according to the exemplary embodiment.

### DETAILED DESCRIPTION

Hereinafter, an exemplary embodiment of the present disclosure will be described in detail on the basis of the drawings.

<Information Processing System 1>

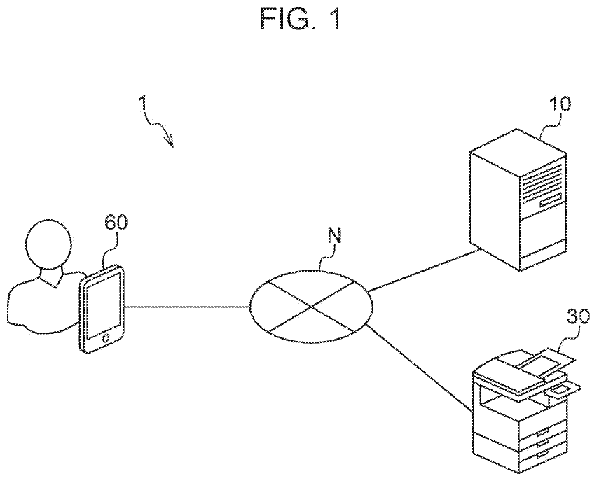

First, an information processing system 1 according to the exemplary embodiment will be described. FIG. 1 is a schematic diagram illustrating the information processing system 1.

The information processing system 1 is a system that processes information, and as illustrated in FIG. 1, is provided with a multi-function device 30, a user terminal 60, and an information processing apparatus 10. The multi-function device 30, the user terminal 60, and the information processing apparatus 10 are interconnected through a wired or wireless communication channel N such as the Internet or an intranet. Hereinafter, specific configurations of the multi-function device 30, the user terminal 60, and the information processing apparatus 10 will be described.

<Multi-Function Device 30>

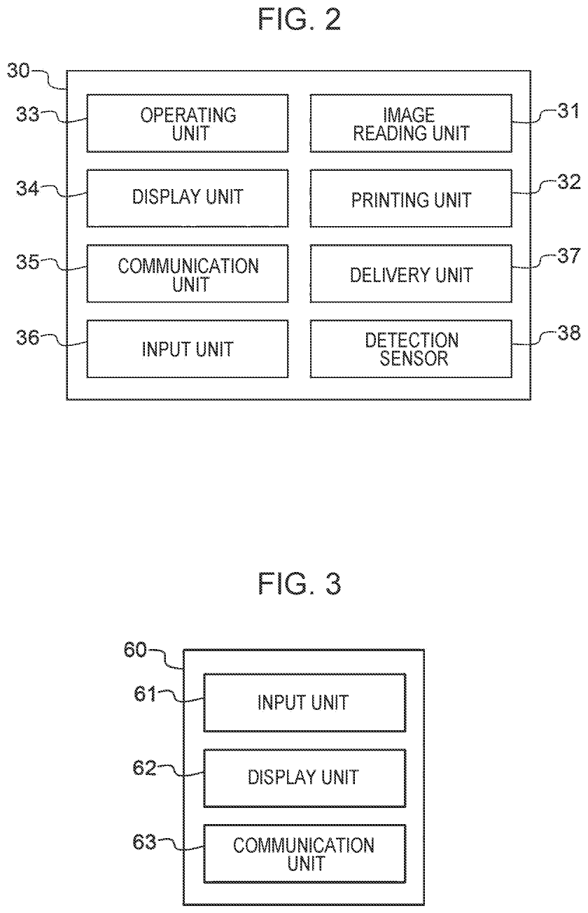

FIG. 2 is a block diagram illustrating an example of a hardware configuration of the multi-function device 30. The multi-function device 30 illustrated in FIG. 2 is an example of a printer. The multi-function device 30 is a device that executes a print process, a scan process, a copy process, a facsimile process, and the like.

The print process is a process of printing (that is, forming an image) onto a recording medium. Thus, the print process may also be thought of as an image forming process. The scan process is a process of reading an image. The copy process is a process of forming an image read by the scan process onto a recording medium. The facsimile process is a process of converting an image into an electrical signal for transmission or reception. Note that an image may contain text.

Here, “printing” refers to forming an image, and as described later, “printing” encompasses not only the case of forming an image onto a recording medium according to an electrophotographic system, but also the case of forming an image onto a recording medium according to another system, such as an inkjet system. Moreover, in one example, the multi-function device 30 is installed in a facility such as a cashierless convenience store or other shop. An example of the facility is not limited to a commercial facility such as a store, and may also be a public facility (such as a city hall or a library).

Specifically, as illustrated in FIG. 2, the multi-function device 30 is provided with an image reading unit 31, a printing unit 32, an operating unit 33, a display unit 34, a communication unit 35, an input unit 36, multiple delivery units 37, and multiple detection sensors 38.

The image reading unit 31 is a component (for example, a scanner) that reads an image of a document. The image reading unit 31 optically reads and converts an image of a document into an electrical signal, thereby generating image data.

The printing unit 32 is a component that prints (that is, a component that forms an image) onto a recording medium such as paper. The printing unit 32 prints according to an electrophotographic system in which the steps of charging, exposing, developing, transferring, and fusing are performed, for example. In the multi-function device 30, the recording medium on which printing has been performed (that is, printed material) is delivered into any of the delivery units 37. Note that the printing unit 32 may also print into a recording medium according to another system, such as an inkjet system.

Each of the multiple delivery units 37 is a component into which printed material is delivered. The delivery units 37 are components from which printed material is retrievable without user authentication. Specifically, the delivery units 37 are configured to be continuously open delivery units from which printed material is retrievable not only by a user who has given a print instruction, but also by a third party who has not given a print instruction.

The detection sensors 38 are an example of a detection unit, and are sensors that detect printed material delivered into the delivery units 37. In one example, the detection sensors 38 are configured as contactless sensors, such as transmissive or reflective optical sensors, for instance. Note that in one example, the detection unit may also be a contact sensor or the like that makes contact with printed material to thereby detect printed material delivered into any of the delivery units 37, for instance, and any of various types of detection units may be used.

Each of the multiple detection sensors 38 is provided to each of the multiple delivery units 37, and detects printed material delivered into each of the multiple delivery units 37. By having one of the detection sensors 38 detect printed material, it is possible to detect that printed material has been delivered into the delivery unit 37 provided with the corresponding detection sensor 38.

Moreover, by having one of the detection sensors 38 detect printed material, it is possible to detect that the delivery unit 37 provided with the corresponding detection sensor 38 is in use from among the multiple delivery units 37.

Also, by having one of the detection sensors 38 no longer detect printed material after having detected printed material, it is possible to detect that printed material has been retrieved from the corresponding delivery unit 37.

Information indicating that one of the detection sensors 38 has detected printed material (hereinafter referred to as printed material detection information) is transmitted from the multi-function device 30 to the information processing apparatus 10. Also, if one of the detection sensor 38 no longer detects printed material after having detected printed material, information indicating that printed material has been retrieved (hereinafter referred to as retrieval information) is transmitted from the multi-function device 30 to the information processing apparatus 10.

The operating unit 33 is a component that accepts input operations performed by a user. Specifically, the operating unit 33 is configured as input keys and a touch panel, for example.

The display unit 34 is a component that displays presentation information to be presented to the user. For example, the display unit 34 displays information pertaining to the processing content (for example, the type of processing and details of settings) of processing executed by the multi-function device 30 as the presentation information. Note that in the case where the operating unit 33 is configured as a touch panel, the display unit 34 may also include the touch panel as the operating unit 33.

The communication unit 35 is a component for communicating with other equipment such as the information processing apparatus 10 and the user terminal 60. The communication unit 35 communicates with other equipment through the use of the wired or wireless communication channel N such as the Internet or an intranet. Note that although the communication unit 35 is provided in the multi-function device 30 in the exemplary embodiment, the multi-function device 30 may also be configured to be provided as a separate apparatus.

In the multi-function device 30, the print process is executed by causing the printing unit 32 to form an image onto a recording medium such as paper on the basis of print information (including image data). The multi-function device 30 is capable of executing a remote print process as the print process. In the remote print process, for example, the information processing apparatus 10 receives a print instruction from the user terminal 60, and the information processing apparatus 10 transmits print information (including image data) included in the print instruction to the multi-function device 30. The multi-function device 30 prints on the basis of the print information acquired from the information processing apparatus 10 through the communication unit 35, without involving an operation of giving a print instruction performed by the user on the operating unit 33. Note that the image data that the information processing apparatus 10 transmits to the multi-function device 30 is not limited to being image data transmitted from the user terminal 60, and may also be image data stored in advance in the information processing apparatus 10.

<User Terminal 60>

FIG. 3 is a block diagram illustrating an example of a hardware configuration of the user terminal 60 according to the exemplary embodiment. The user terminal 60 is a terminal such as a smartphone, tablet, or personal computer that can be carried by the user, for example. The user terminal 60 is provided with an input unit 61, a display unit 62, and a communication unit 63.

The input unit 61 is a component that accepts instructions inputted by the user. Specifically, the input unit 61 is configured as input keys and a touch panel on which the user performs input operations, for example.

The display unit 62 is a component that displays presentation information to be presented to the user. The display unit 62 displays unlock information as the presentation information, for example. Note that in one example, the display unit 62 is configured as a display that includes a touch panel serving as the input unit 61.

The communication unit 63 is a component for communicating with other equipment such as the information processing apparatus 10 and the multi-function device 30. The communication unit 63 communicates with other equipment through the use of the wired or wireless communication channel N such as the Internet or an intranet.

In the user terminal 60, a print instruction inputted by the user through the input unit 61 is transmittable to the information processing apparatus 10 through the communication unit 63.

<Information Processing Apparatus 10>

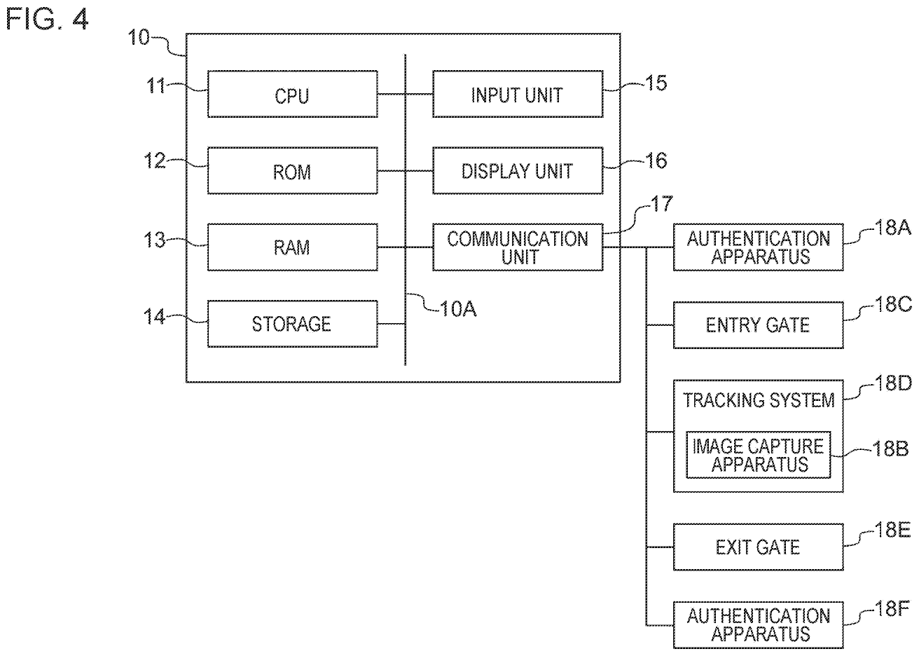

FIG. 4 is a block diagram illustrating an example of a hardware configuration of the information processing apparatus 10 according to the exemplary embodiment. The information processing apparatus 10 illustrated in FIG. 4 is an example of a control apparatus, and is configured as a server apparatus installed in a facility such as a store, or in a headquarters that manages multiple facilities, for example. Note that an example of the control apparatus is not limited to the information processing apparatus 10, and may also be a control apparatus installed in or attached to the multi-function device 30, or any other apparatus capable of controlling the multi-function device 30.

The information processing apparatus 10 has the functions of a computer, and as illustrated in FIG. 4, is provided a central processing unit (CPU) 11, read-only memory (ROM) 12, random access memory (RAM) 13, storage 14, an input unit 15, a display unit 16, and a communication unit 17.

The CPU 11, ROM 12, RAM 13, storage 14, input unit 15, display unit 16, and communication unit 17 are interconnected by a bus 10A. Additionally, the information processing apparatus 10 is connected to authentication apparatuses 18A and 18F, a tracking system 18D, an entry gate 18C, and an exit gate 18E through the communication unit 17. The CPU 11 is an example of a processor.

The CPU 11 centrally controls the information processing apparatus 10 as a whole. The RAM 12 stores various programs, including a control program used in the exemplary embodiment, various data, and the like. The RAM 13 is memory used as a work area when the various programs are executed. The CPU 11 performs various processing by loading a program stored in the ROM 12 into the RAM 13 and executing the program. The control program is an example of an execution program.

The storage 14 is configured as a hard disk drive (HDD), a solid-state drive (SSD), or flash memory, for example, and stores various programs, various data, and the like. The storage 14 according to the exemplary embodiment stores a user identification database (DB) to be used when authenticating the user, for example. Note that the storage 14 may also store the control program and the like.

The input unit 15 is a component that accepts input operations performed by the user. Specifically, in one example, the input unit 15 is configured as a mouse and keyboard that accept text input and the like. In one example, the display unit 16 is configured as a display that displays images.

The communication unit 17 is a component for communicating with other equipment such as the multi-function device 30 and the user terminal 60. The communication unit 17 communicates with other equipment through the use of the wired or wireless communication channel N such as the Internet or an intranet.

<Configuration of Other Components of Information Processing System 1>

The information processing apparatus 10 is further provided with authentication apparatuses 18A and 18F, a tracking system 18D, an entry gate 18C, and an exit gate 18E.

The entry gate 18C is installed at an entrance to the facility, and is opened to allow the user to enter the facility. The opening and closing of the entry gate 18C are controlled by the information processing apparatus 10.

The authentication apparatus 18A is an apparatus for authenticating the user, and detects identification information that identifies the user. In one example, the authentication apparatus 18A is installed at the entrance to the facility. If the information processing apparatus 10 authenticates the user on the basis of identification information detected by the authentication apparatus 18A, the entry gate 18C of the facility is opened and the user is allowed to enter.

The exit gate 18E is installed at an exit from the facility, and is opened to allow the user to exit the facility. The opening and closing of the exit gate 18E are controlled by the information processing apparatus 10.

The authentication apparatus 18F is an apparatus for authenticating the user, and detects identification information that identifies the user. The authentication apparatus 18F is installed at the exit from the facility. If the information processing apparatus 10 authenticates the user on the basis of identification information detected by the authentication apparatus 18F, the exit gate 18E of the facility is opened and the user is allowed to exit.

The identification information in the authentication apparatuses 18A and 18F is issued by registering the user in advance as a user of the facility, for example. Specific examples of the identification information include an identification image such as a two-dimensional code or a barcode. The user is authenticated by causing the user terminal 60 to display the identification image and causing the authentication apparatus 18A or 18F to read the displayed identification image.

User authentication may also be performed using an integrated circuit (IC) card or biometric authentication, for example. In this case, apparatuses that detect identification information contained in the IC card or identification information (such as a fingerprint, facial features, or a voiceprint) associated with biometric authentication information are used as the authentication apparatuses 18A and 18F. The identification information detected by the authentication apparatuses 18A and 18F is transmitted to the information processing apparatus 10.

The tracking system 18D is a system that tracks the user moving inside the facility after being authenticated when entering the facility. The tracking system 18D includes multiple image capture apparatuses 18B that capture images of the user inside the facility. The multiple image capture apparatuses 18B are provided around the multi-function device 30 and include a particular image capture apparatus 18B (for example, a camera) that captures an image of the user retrieving printed material from one of the delivery units 37. Specifically, the particular image capture apparatus 18B may be provided on a piece of equipment, a structure (such as the ceiling, a wall, or pillar, for example), or an installation (such as a desk, for example) near the multi-function device 30.

The multiple image capture apparatuses 18B have an image capture range that covers the entire movement range of the user inside the facility, and detect the position of the user inside the facility. Information pertaining to images captured by the image capture apparatuses 18B (hereinafter referred to as captured image information) is transmitted from the tracking system 18D to the information processing apparatus 10. The captured image information is an example of tracking information. The particular image capture apparatus 18B provided near the multi-function device 30 is an example of a detection apparatus. Information pertaining to an image captured by the particular image capture apparatus 18B is an example of detection information.

<Functional Configuration of Information Processing Apparatus 10>

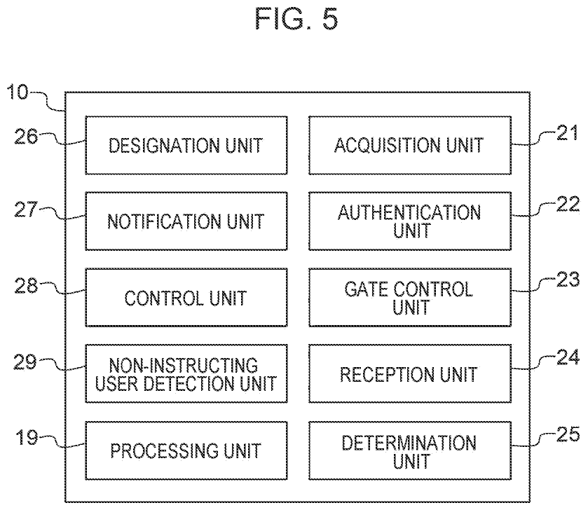

In the information processing apparatus 10, the CPU 11 executes the control program to thereby achieve various functions for controlling the multi-function device 30. Hereinafter, a functional configuration achieved through cooperation between the CPU 11 serving as a hardware resource and the control program serving as a software resource will be described. FIG. 5 is a block diagram illustrating an example of a functional configuration of the information processing apparatus 10 according to the exemplary embodiment.

In one example, as illustrated in FIG. 5, the information processing apparatus 10 is provided with an acquisition unit 21, an authentication unit 22, a gate control unit 23, a reception unit 24, a determination unit 25, a designation unit 26, a notification unit 27, a control unit 28, a non-instructing user detection unit 29, and a processing unit 19.

The acquisition unit 21 acquires identification information from the authentication apparatuses 18A and 18F. The acquisition unit 21 also acquires captured image information from the tracking system 18D including the image capture apparatuses 18B. The acquisition unit 21 also acquires printed material detection information and retrieval information from the multi-function device 30.

The authentication unit 22 compares the acquired identification information to user identification information registered in advance to identify and authenticate the user. The user identification information is stored in the storage 14, for example.

If the authentication unit 22 authenticates the user with the identification information acquired from the authentication apparatus 18A, the gate control unit 23 controls the entry gate 18C so as to open the entry. If the authentication unit 22 authenticates the user with the identification information acquired from the authentication apparatus 18F, the gate control unit 23 controls the exit gate 18E so as to open the exit.

The reception unit 24 receives a print instruction from the user terminal 60. The print instruction includes print information such as image data, the number of pages to print, the paper size, a color setting (such as black and white printing or color printing, for example), and the image quality. Hereinafter, the user who gives the print instruction from the user terminal 60 is referred to as the “instructing user”, and a user different from the instructing user is referred to as the “non-instructing user”.

If the reception unit 24 receives the print instruction from the user terminal 60, the determination unit 25 determines whether an empty delivery unit 37 exists among the multiple delivery units 37 on the basis of the printed material detection information acquired by the acquisition unit 21.

If the determination unit 25 that an empty delivery unit 37 exists, and if there is one empty delivery unit 37, the designation unit 26 designates the empty delivery unit 37 as the delivery unit 37 into which printed material is to be delivered. If the determination unit 25 that an empty delivery unit 37 exists, and if there are multiple empty delivery units 37, the designation unit 26 designates one among the multiple empty delivery units 37 as the delivery unit 37 into which printed material is to be delivered. In one example, the designation unit 26 designates the delivery unit 37 disposed uppermost or lowermost among the multiple delivery units 37 as the delivery unit 37 into which printed material is to be delivered.

The notification unit 27 notifies the user terminal 60 associated with the instructing user with information about the delivery unit 37 into which printed material is to be delivered from among the multiple delivery units 37. Specifically, the notification unit 27 notifies the user terminal 60 associated with the instructing user with information (hereinafter referred to as delivery unit identification information) identifying the delivery unit 37 that the designation unit 26 has designated as the delivery unit 37 into which printed material is to be delivered. Specifically, the delivery unit identification information is information such as “the printed material will be delivered into the nth delivery unit 37”, for example.

If an empty delivery unit 37 does not exist among the multiple delivery units 37, the notification unit 27 notifies the user terminal 60 associated with the instructing user with information indicating that an empty delivery unit 37 does not exist. Specifically, if the determination unit 25 determines that an empty delivery unit 37 does not exist, the notification unit 27 notifies the user terminal 60 associated with the instructing user that an empty delivery unit 37 does not exist among the multiple delivery units 37.

The control unit 28 is a functional unit that controls operations by the multi-function device 30. If the reception unit 24 receives a print instruction from the user terminal 60 and the designation unit 26 designates the delivery unit 37 into which printed material is to be delivered, the control unit 28 executes a print control that causes the multi-function device 30 to print without involving an operation of giving a print instruction performed by the user on the multi-function device 30, and causes printed material to be delivered into the delivery unit 37 designated by the designation unit 26.

In addition, the control unit 28 controls the multi-function device 30 such that printed materials based on multiple print instructions associated with the same user or users in a preset group are delivered into a single delivery unit 37.

Note that in the case of causing the multi-function device 30 to execute printing, the control unit 28 transmits print information to the multi-function device 30.

If the retrieval of the printed material from the delivery unit 37 is detected (that is, if the acquisition unit 21 acquires retrieval information), the non-instructing user detection unit 29 detects, on the basis of captured image information acquired by the acquisition unit 21, whether the user who retrieved the printed material from the delivery unit 37 is the non-instructing user.

If an unauthorized state occurs in which the non-instructing user retrieves printed material from the delivery unit 37 (that is, if the non-instructing user detection unit 29 detects that the user who retrieved the printed material from the delivery unit 37 is the non-instructing user), the processing unit 19 performs a resolution process promoting resolution of the unauthorized state.

The processing unit 19 performs, as the resolution process, a notification process of notifying equipment external to the multi-function device 30 that the unauthorized state has occurred. Specifically, the processing unit 19 performs, as the notification process, a process of notifying the user terminal 60 associated with the non-instructing user that the unauthorized state has occurred.

The processing unit 19 also performs, as the resolution process, a prohibition process that prohibits the non-instructing user from leaving the facility. Specifically, the non-instructing user is prohibited from leaving the facility by causing the exit gate 18E not to open if authentication of the non-instructing user is performed in the authentication apparatus 18F.

Note that in the information processing apparatus 10, a fee for printed material may be settled automatically when the user submits to authentication at the authentication apparatus 18F and exits the facility.

<Control Processing According to Exemplary Embodiment>

Next, an example of control processing according to the exemplary embodiment will be described.

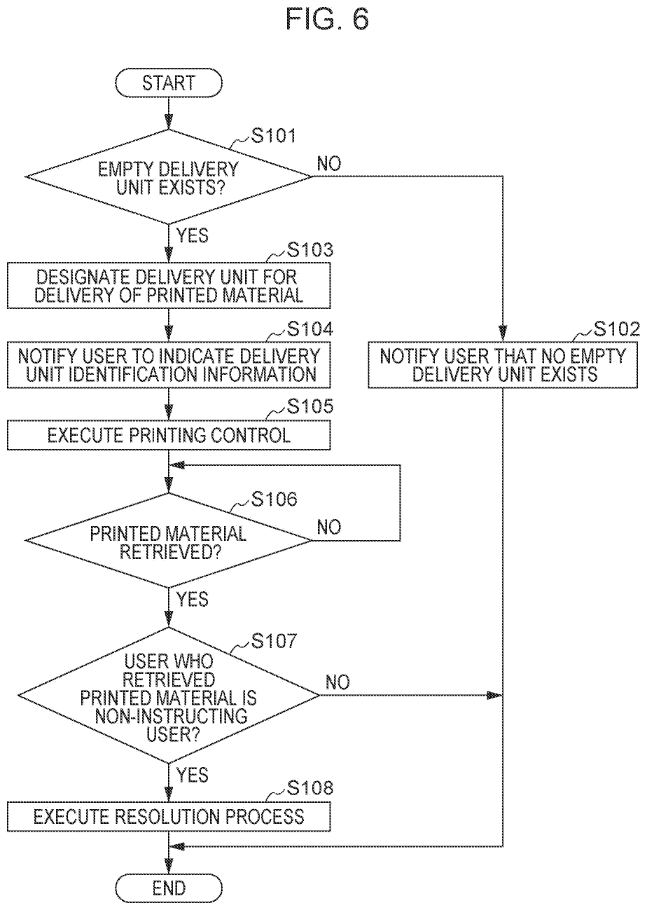

FIG. 6 is a flowchart illustrating an example of a flow of control processing executed by the information processing apparatus 10.

In the exemplary embodiment, the control processing is executed by causing the CPU 11 to read out the control program from the ROM 12 or the storage 14 and execute the control program. In one example, execution of the control processing is initiated if the information processing apparatus 10 receives a print instruction from the user terminal 60.

As illustrated in FIG. 6, if the control processing is initiated, the CPU 11 determines whether any of the multiple delivery units 37 are empty (step S101).

In the case of determining that an empty delivery unit 37 does not exist (step S101: NO), the CPU 11 notifies the user terminal 60 associated with the instructing user with information indicating that an empty delivery unit 37 does not exist (step S102), and ends the control processing.

In the case of determining that an empty delivery unit 37 exists (step S101: YES), the CPU 11 designates the delivery unit 37 into which printed material is to be delivered (step S103).

Next, the CPU 11 notifies the user terminal 60 associated with the instructing user of delivery unit identification information identifying the delivery unit 37 designated as the delivery unit 37 into which printed material is to be delivered (step S104). That is, in step S104, the user terminal 60 associated with the instructing user is notified with information about the delivery unit 37 into which printed material is to be delivered from among the multiple delivery units 37.

Next, the CPU 11 executes a print control that causes the multi-function device 30 to print without involving an operation of giving a print instruction performed by the user on the multi-function device 30, and causes printed material to be delivered into the designated delivery unit 37 (step S105). Note that in the case where multiple print instructions are given by the same user or by users in a preset group, the CPU 11 controls the multi-function device 30 such that printed materials based on the multiple print instructions associated with the same user or users in the preset group are delivered into a single delivery unit 37.

Next, the CPU 11 determines whether the printed material has been retrieved from the delivery unit 37 (step S106). In the case of determining that the printed material has been retrieved from the delivery unit 37, the CPU 11 determines whether the user who retrieved the printed material is the non-instructing user (step S107). Note that the CPU 11 repeats step S106 until it is determined that printed material has been retrieved from the delivery unit 37.

In the case of determining that the user who retrieved the printed material is the non-instructing user in step S107 (step S107: YES), the CPU 11 executes the resolution process promoting resolution of the unauthorized state of the non-instructing user retrieving the printed material from the delivery unit 37, and ends the control processing.

The CPU 11 performs, as the resolution process, a notification process of notifying equipment external to the multi-function device 30 that the unauthorized state has occurred. Specifically, the CPU 11 performs, as the notification process, a process of notifying the user terminal 60 associated with the non-instructing user that the unauthorized state has occurred. Additionally, the CPU 11 performs, as the resolution process, a prohibition process that prohibits the non-instructing user from leaving the facility.

In this way, in the exemplary embodiment, if an unauthorized state occurs in which the non-instructing user retrieves printed material from the delivery unit 37, the CPU 11 performs the resolution process promoting resolution of the unauthorized state.

Note that in the case of determining that the user who retrieved the printed material is the instructing user in step S107 (step S107: NO), the CPU 11 ends the control processing without executing the resolution process.

<Action According to Exemplary Embodiment>

Next, the action according to exemplary embodiment will be described.

According to the exemplary embodiment, if an unauthorized state occurs in which the non-instructing user retrieves printed material from the delivery unit 37, the CPU 11 performs the resolution process promoting resolution of the unauthorized state.

Accordingly, the takeaway of printed material by the non-instructing user may be mitigated compared to the case where the CPU 11 performs only print control with respect to the multi-function device 30.

Also, in the exemplary embodiment, the CPU 11 performs, as the resolution process, a notification process of notifying equipment external to the multi-function device 30 that the unauthorized state has occurred.

Accordingly, a person external to the multi-function device 30 may be prompted to resolve the unauthorized state compared to the case where the CPU 11 performs, as the resolution process, a process other than the notification process.

Also, in the exemplary embodiment, the CPU 11 performs, as the notification process, a process of notifying the user terminal 60 associated with the non-instructing user that the unauthorized state has occurred.

Accordingly, the non-instructing user may be prompted to resolve the unauthorized state compared to the case where the CPU 11 performs, as the notification process, a process of notifying only the user terminal 60 associated with the instructing user that the unauthorized state has occurred.

Also, in the exemplary embodiment, the CPU 11 performs, as the resolution process, a prohibition process that prohibits the non-instructing user from leaving the facility. Accordingly, the non-instructing user may be compelled to resolve the unauthorized state compared to the case where the CPU 11 performs only the notification process as the resolution process.

Also, in the exemplary embodiment, the CPU 11 notifies the user terminal 60 associated with the instructing user with information about the delivery unit 37 into which printed material is to be delivered from among the multiple delivery units 37.

Accordingly, the taking of the wrong printed material by the instructing user may be mitigated compared to the case where the CPU 11 uses only a notification unit (for example, the display unit 34) provided to the display unit 34 to give notice of information about the delivery unit 37 into which the printed material is to be delivered.

Also, in the exemplary embodiment, the CPU 11 controls the multi-function device 30 such that printed materials based on multiple print instructions associated with the same user or users in a preset group are delivered into a single delivery unit 37.

Accordingly, the utilization of the delivery units 37 may be lowered compared to the case where the CPU 11 controls the multi-function device 30 such that printed materials based on multiple print instructions are delivered into a different delivery unit 37 for each print instruction.

In the exemplary embodiment, if an empty delivery unit 37 does not exist among the multiple delivery units 37, the CPU 11 notifies the user terminal 60 associated with the instructing user with information indicating that an empty delivery unit 37 does not exist.

Accordingly, the instructing user may be made to recognize that delivery of the printed material into a delivery unit 37 is unavailable compared to the case where the CPU 11 notifies the user terminal 60 associated with the instructing user with only information indicating the delivery unit 37 into which printed material is to be delivered from among the multiple delivery units 37.

In the exemplary embodiment, if the retrieval of printed material from the delivery unit 37 is detected by the detection sensor 38 provided to the delivery unit 37, the CPU 11 detects whether the user who retrieved the printed material from the delivery unit 37 is the non-instructing user on the basis of captured image information acquired from the image capture apparatuses 18B provided around the multi-function device 30.

Accordingly, the accuracy of detecting the non-instructing user may be raised compared to the case where the CPU 11 detects whether the user who retrieved the printed material from the delivery unit 37 is the non-instructing user on the basis of only captured image information acquired from the image capture apparatuses 18B, without being based on a detection result from the detection sensor 38 provided to the delivery unit 37.

Specifically, in the exemplary embodiment, if the retrieval of printed material from the delivery unit 37 is detected by the detection sensor 38 provided to the delivery unit 37, the CPU 11 detects whether the user who retrieved the printed material from the delivery unit 37 is the non-instructing user on the basis of captured image information acquired from the tracking system 18D.

Accordingly, the accuracy of detecting the non-instructing user may be raised compared to the case where the CPU 11 detects whether the user who retrieved the printed material from the delivery unit 37 is the non-instructing user on the basis of only captured image information acquired from the image capture apparatuses 18B provided around the multi-function device 30.

<Exemplary Modifications of Information Processing Apparatus 10>

In the exemplary embodiment, if an unauthorized state occurs in which the non-instructing user retrieves printed material from the delivery unit 37, the CPU 11 performs, as the resolution process promoting resolution of the unauthorized state, the notification process of notifying equipment external to the multi-function device 30 that the unauthorized state has occurred and the prohibition process of prohibiting the non-instructing user from leaving the facility, but the resolution process is not limited to the above. For example, the CPU 11 may also perform one of either the notification process or the prohibition process as the resolution process. That is, the CPU 11 may also perform a process other than the notification process as the resolution process.

Also, in the exemplary embodiment, the CPU 11 performs, as the notification process of notifying equipment external to the multi-function device 30 that the unauthorized state has occurred, a process of notifying the user terminal 60 associated with the non-instructing user that the unauthorized state has occurred, but the notification process is not limited to the above. For example, the CPU 11 may perform, as the notification process, at least one of a process of sounding a warning tone from the multi-function device 30, a process of displaying a warning on the display unit 34 of the multi-function device 30, a process of notifying the user terminal 60 associated with the instructing user that the unauthorized state has occurred, and a process of notifying an employee of the facility that the unauthorized state has occurred, instead of or in addition to the process of notifying the user terminal 60 associated with the non-instructing user that the unauthorized state has occurred.

Also, in the exemplary embodiment, the CPU 11 notifies the user terminal 60 associated with the instructing user with information about the delivery unit 37 into which printed material is to be delivered from among the multiple delivery units 37, but is not limited to the above. For example, the CPU 11 may also use a notification unit (for example, the display unit 34) provided to the multi-function device 30 to give notice of the above information instead of, or in addition to, notifying the user terminal 60 associated with the instructing user with the above information.

Also, in the exemplary embodiment, the CPU 11 controls the multi-function device 30 such that printed materials based on multiple print instructions associated with the same user or users in a preset group are delivered into a single delivery unit 37, but is not limited to the above. For example, the CPU 11 may also control the multi-function device 30 such that printed materials based on multiple print instructions are delivered into a different delivery unit 37 for each print instruction.

Also, in the exemplary embodiment, if an empty delivery unit 37 does not exist among the multiple delivery units 37, the CPU 11 notifies the user terminal 60 associated with the instructing user with information indicating that an empty delivery unit 37 does not exist, but is not limited to the above. For example, the CPU 11 may also be configured to notify the user terminal 60 associated with the instructing user with only information about the delivery unit 37 into which printed material is to be delivered from among the multiple delivery units 37.

Also, in the exemplary embodiment, if the retrieval of printed material from the delivery unit 37 is detected by the detection sensor 38 provided to the delivery unit 37, the CPU 11 detects whether the user who retrieved the printed material from the delivery unit 37 is the non-instructing user on the basis of captured image information acquired from the image capture apparatuses 18B provided around the multi-function device 30, but is not limited to the above. For example, the CPU 11 may also be configured to detect whether the user who retrieved the printed material from the delivery unit 37 is the non-instructing user on the basis of only captured image information acquired from the image capture apparatuses 18B, without being based on a detection result from the detection sensor 38 provided to the delivery unit 37.

Also, in the exemplary embodiment, if the retrieval of printed material from the delivery unit 37 is detected by the detection sensor 38 provided to the delivery unit 37, the CPU 11 detects whether the user who retrieved the printed material from the delivery unit 37 is the non-instructing user on the basis of captured image information acquired from the tracking system 18D specifically, but is not limited to the above. For example, CPU 11 may also be configured to detect whether the user who retrieved the printed material from the delivery unit 37 is the non-instructing user on the basis of only captured image information acquired from the image capture apparatuses 18B provided around the multi-function device 30.

In the exemplary embodiments, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiment above, and may be changed.

In the exemplary embodiment, the control processing according to the exemplary embodiment is executed by the standalone information processing apparatus 10, but may also be executed through the cooperation of multiple information processing apparatuses. In this case, one information processing apparatus among the multiple information processing apparatuses may execute processing related to the entry, exit, and tracking of the user in the facility, processing related to payment, and the like, while another information processing apparatus may execute processing related to printing.

Also, in the exemplary embodiment, the CPU 11 detects whether the user who retrieved the printed material from the delivery unit 37 is the non-instructing user on the basis of captured image information from the multiple image capture apparatuses 18B provided in the tracking system 18D, but is not limited to the above. For example, CPU 11 may also detect whether the user who retrieved the printed material from the delivery unit 37 is the non-instructing user on the basis of captured image information from a single image capture apparatus 18B provided near the multi-function device 30, or on or in the multi-function device 30 itself.

Also, in the exemplary embodiment, the unauthorized state is taken to be a state of the non-instructing user retrieving the printed material from the delivery unit 37, but the unauthorized state may encompass not only the state of the non-instructing user retrieving the printed material from the delivery unit 37 but also the case where the non-instructing user attempts to retrieve the printed material from the delivery unit 37. In this case, a configuration is possible in which a warning is issued to the non-instructing user if the non-instructing user touches the printed material in the delivery unit 37, for example.

<Other Exemplary Modifications 22

In the exemplary embodiment, the multi-function device 30 is provided with multiple delivery units 37, but is not limited thereto. For example, the multi-function device 30 may also be provided with only a single delivery unit 37. In this case, if the reception unit 24 receives the print instruction from the user terminal 60, the CPU 11 determines whether the empty delivery unit 37 is empty on the basis of the printed material detection information acquired by the acquisition unit 21. In the case of determining that the delivery unit 37 is empty, the CPU 11 executes a print control that causes the multi-function device 30 to print without involving an operation of giving a print instruction performed by the user on the multi-function device 30, and causes printed material to be delivered into the delivery unit 37. Consequently, the CPU 11 does not have to designate the delivery unit 37 into which the printed material is to be delivered from among multiple delivery units 37. Moreover, the CPU 11 does not have to notify the user terminal 60 associated with the instructing user with information about the delivery unit 37 into which printed material is to be delivered.

In the exemplary embodiment, the image capture apparatuses 18B that capture images of the user retrieving the printed material from the delivery unit 37 are provided around the multi-function device 30, but are not limited thereto. The image capture apparatuses 18B may also be provided on or in the multi-function device 30 itself.

The present disclosure is not limited to the exemplary embodiment above, and various modifications, alterations, and improvements are possible without deviating from the gist of the present disclosure. For example, the exemplary modifications described above may also be plurally combined, as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

(Appendix)

(((1)))

A control apparatus comprising a processor configured to:
receive a print instruction from a user terminal;
execute a print control that causes a printer to print without involving an operation of giving a print instruction performed by a user on the printer, and causes printed material produced by the printing to be delivered into a delivery unit from which the printed material is retrievable without user authentication; and
perform a resolution process if an unauthorized state occurs in which a non-instructing user who is different from an instructing user who gave the print instruction retrieves the printed material from the delivery unit, the resolution process promoting resolution of the unauthorized state.
   (((2)))

The control apparatus according to (((1))), wherein the processor is configured to perform, as the resolution process, a notification process of notifying equipment external to the printer that the unauthorized state has occurred.

(((3)))

The control apparatus according to (((2))), wherein the processor is configured to perform, as the notification process, a process of notifying a user terminal associated with the non-instructing user that the unauthorized state has occurred.

(((4)))

The control apparatus according to any one of (((1))) to (((3))), wherein:
the printer is installed in a facility; and
the processor is configured to perform, as the resolution process, a prohibition process that prohibits the non-instructing user from leaving the facility.
   (((5)))

The control apparatus according to any one of (((1))) to (((4))), wherein:
a plurality of delivery units are provided; and
the processor is configured to notify a user terminal associated with the instructing user with information about the delivery unit into which the printed material is to be delivered from among the plurality of delivery units.
   (((6)))

The control apparatus according to (((5))), wherein the processor is configured to control the printer such that printed materials based on a plurality of print instructions associated with the same user or users in a preset group are delivered into a single delivery unit.

(((7)))

The control apparatus according to (((5))), wherein the processor is configured to notify, if an empty delivery unit does not exist among the plurality of delivery units, the user terminal associated with the instructing user with information indicating that an empty delivery unit does not exist.

(((8)))

The control apparatus according to any one of (((1))) to (((7))), wherein:
a detection apparatus that detects a user retrieving the printed material from the delivery unit is provided to at least one of the printer and around the printer; and
the processor is configured to detect, if retrieval of the printed material from the delivery unit is detected by the detection unit provided to the delivery unit, whether the user retrieving the printed material from the delivery unit is the non-instructing user on a basis of detection information acquired from the detection apparatus.
   (((9)))

The control apparatus according to (((8))), wherein:
the printer is installed in a facility;
the facility is provided with a tracking system that tracks a user moving inside the facility after being authenticated when entering the facility, the tracking system including the detection apparatus; and
the processor is configured to detect, if retrieval of the printed material from the delivery unit is detected by the detection unit, whether the user retrieving the printed material from the delivery unit is the non-instructing user on a basis of user tracking information detection information acquired from the tracking system.
   (((10)))

A program causing a computer to execute a process comprising:
executing a print control if a print instruction is received from a user terminal, the print control causing a printer to print without involving an operation of giving a print instruction performed by a user on the printer, and causing printed material produced by the printing to be delivered into a delivery unit from which the printed material is retrievable without user authentication; and
executing a process if an unauthorized state occurs in which a non-instructing user who is different from an instructing user who gave the print instruction retrieves the printed material from the delivery unit, the process promoting resolution of the unauthorized state.

What is claimed is:

1. A control apparatus comprising:
a processor configured to:
receive a print instruction from a user terminal;
execute a print control that causes a printer to print without involving an operation of giving a print instruction performed by a user on the printer, and causes printed material produced by the printing to be delivered into a delivery unit from which the printed material is retrievable without user authentication; and
perform a resolution process if an unauthorized state occurs in which a non-instructing user who is different from an instructing user who gave the print instruction retrieves the printed material from the delivery unit, the resolution process promoting resolution of the unauthorized state.

2. The control apparatus according to claim 1, wherein the processor is configured to perform, as the resolution process, a notification process of notifying equipment external to the printer that the unauthorized state has occurred.

3. The control apparatus according to claim 2, wherein the processor is configured to perform, as the notification process, a process of notifying a user terminal associated with the non-instructing user that the unauthorized state has occurred.

4. The control apparatus according to claim 1, wherein:
the printer is installed in a facility; and
the processor is configured to perform, as the resolution process, a prohibition process that prohibits the non-instructing user from leaving the facility.

5. The control apparatus according to claim 1, wherein:
a plurality of delivery units are provided; and
the processor is configured to notify a user terminal associated with the instructing user with information about the delivery unit into which the printed material is to be delivered from among the plurality of delivery units.

6. The control apparatus according to claim 5, wherein the processor is configured to control the printer such that printed materials based on a plurality of print instructions associated with the same user or users in a preset group are delivered into a single delivery unit.

7. The control apparatus according to claim 5, wherein the processor is configured to notify, if an empty delivery unit does not exist among the plurality of delivery units, the user terminal associated with the instructing user with information indicating that an empty delivery unit does not exist.

8. The control apparatus according to claim 1, wherein:
a detection apparatus that detects a user retrieving the printed material from the delivery unit is provided to at least one of the printer and around the printer; and
the processor is configured to detect, if retrieval of the printed material from the delivery unit is detected by the detection unit provided to the delivery unit, whether the user retrieving the printed material from the delivery unit is the non-instructing user on a basis of detection information acquired from the detection apparatus.

9. The control apparatus according to claim 8, wherein:
the printer is installed in a facility;
the facility is provided with a tracking system that tracks a user moving inside the facility after being authenticated when entering the facility, the tracking system including the detection apparatus; and
the processor is configured to detect, if retrieval of the printed material from the delivery unit is detected by the detection unit, whether the user retrieving the printed material from the delivery unit is the non-instructing user on a basis of user tracking information detection information acquired from the tracking system.

10. A control method comprising:
executing a print control if a print instruction is received from a user terminal, the print control causing a printer to print without involving an operation of giving a print instruction performed by a user on the printer, and causing printed material produced by the printing to be delivered into a delivery unit from which the printed material is retrievable without user authentication; and
executing a process if an unauthorized state occurs in which a non-instructing user who is different from an instructing user who gave the print instruction retrieves the printed material from the delivery unit, the process promoting resolution of the unauthorized state.

11. A non-transitory computer readable medium storing a program causing a computer to execute a process comprising:
executing a print control if a print instruction is received from a user terminal, the print control causing a printer to print without involving an operation of giving a print instruction performed by a user on the printer, and causing printed material produced by the printing to be delivered into a delivery unit from which the printed material is retrievable without user authentication; and
executing a process if an unauthorized state occurs in which a non-instructing user who is different from an instructing user who gave the print instruction retrieves the printed material from the delivery unit, the process promoting resolution of the unauthorized state.
